(19) United States
(12) Patent Application Publication
(10) Pub. No.: US 2006/0006621 A1
(43) Pub. Date: Jan. 12, 2006

(54) Portable self-contained service cart arrangement

(76) Inventors: Cathy D. Santa Cruz, Reno, NV (US); William E. Adams, Reno, NV (US); Steven M. Waldren, Reno, NV (US); Timothy B. Waldren, Reno, NV (US); Phillip B. Waldren, Sparks, NV (US); Sharon A. Waldren, Sparks, NV (US)

Correspondence Address: Cathy D. Santa Cruz, 7630 Tholl Drive, Reno, NV, 89506, US

(21) Appl. No.: 10/888,835

(22) Filed: Jul. 8, 2004

(51) Int. Cl. B62B 1/00

(52) U.S. Cl. 280/79.3

(57) ABSTRACT

As taught herein, we provide different embodiments for portable self-contained service carts, with each of the carts having a specific use and various tools and equipment for performing specialized tasks.

### FIELD OF THE INVENTION

This invention relates in general to portable tool carts or the like but more particularly pertains to such portable devices that are designed and arranged for containment and/or storage of specific tools used for performing specialized tasks typically associated with a particular job at hand. For example, if such carts are used in the auto body repair business, the noted specialty tasks with the associated tool carts would include an estimating cart, a teardown cart, a production cart, a disassembly/reassemble cart, a bodywork cart, welding cart, mechanical cart, frame cart, etc. However, it is to be noted such service carts may be used within other professional fields of user choice, such as appliance repair, construction, or the like.

### BACKGROUND OF THE INVENTION

As taught within the known prior art, there have been numerous attempts to provide different types of assemblies used for storage or containment of hand tools or the like. For example, there are many different types of portable tool chests, boxes, or carts that are convenient but they are strictly functional for a worker to perform a particular job at hand, such as a carpenters toolbox, a painters toolbox, a window-cleaners toolbox, a welders toolbox, an auto mechanics toolbox, etc. Each of which have been heretofore addressed within various references and their associated fields. However, nowhere within the known prior art has there been taught a specialty service cart or the like which provides the following novel features in combination within one portable cart and which is completely self-contained, does not need any additional hook-ups such as for electricity or compressed air, includes all of the required equipment and tools, and also allows use of a laptop computer therewith. As previously noted, a service cart of the present invention may be used for other professional fields of user choice. Therefore the following is only exemplary of how such service carts may be used in a specialty business such as within the auto body repair service, which has not previously been addressed within the known prior art and this would be most advantageous.

Within the auto body repair industry there are a multiplicity of different tasks incurred on a daily basis, depending on the job at hand. For example, auto body repair shops employ specialists who must be skilled in estimating repair cost, scheduling repairs, assembling/disassembling, welding, painting, etc, each of which require different tools and/or specialized equipment for the particular job. With this in mind, it would be most advantageous to provide different portable carts which are designed for a specific task and wherein the tools and equipment associated with that task are conveniently provided and/or stored therein. It is to be noted that the novelty of the present invention is mainly due to the unique size of the cart as this allows use of the cart in very confined spaces.

### SUMMARY OF THE INVENTION

It is therefore a primary object of the present invention to provide various auto body portable service carts that can be used by different employees for performing particular tasks pertaining to a specified job at hand, such as service carts used for auto body repair.

Yet another object of the present invention is to provide various portable service carts that are cost effective to manufacture, produce, sell, and which also can be made from any suitable materials of engineering choice, such as metal, stainless steel, aluminum, plastic, etc.

Still another object of the present invention is to provide various portable service carts that are easily manipulated by the workman and movable between desired locations. This is very important as a most novel feature of the present cart design is the fact that it is completely self-contained, completely portable, provides means for use of a laptop computer, and allows the workman complete mobility without the need for any electrical hook-ups or compressed air, etc. Thus the present cart design can be used for numerous tasks of user choice, even if not related to auto body repair, as due to the size and shape the cart can be easily maneuvered in between objects within confined spaces. Therefore, other professions such as mechanics, painters, construction workers, or anyone performing a job within a confined space may desire and easily use a cart of this design.

A most important object of the present invention is to provide various portable service carts that overcome the drawbacks and disadvantages associated with the known prior art in a manner heretofore not taught.

Other objects and advantages will be seen when taken into consideration with the following description and specifications.

### BRIEF DESCRIPTION OF THE DRAWINGS

FIG. 1 is substantially a perspective overview of a first embodiment for a portable service cart of the present invention, such as an auto body estimating service cart or the like.

FIG. 2 is substantially a frontal overview of a first embodiment for a service cart of the present invention, such as a portable auto body teardown service cart or the like.

FIG. 3 is substantially a backside view of FIG. 2.

FIG. 4 is substantially an overview of the inside of the door panel of the above teardown service cart including a tool caddy thereon.

### DETAILED DESCRIPTION OF THE DRAWINGS

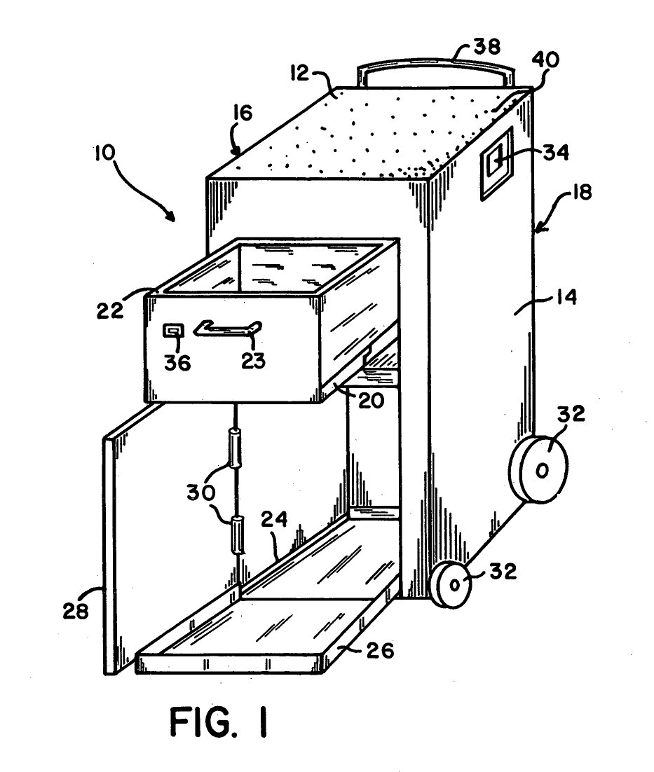

Referring now in detail to the drawings wherein like characters refer to like elements throughout the various views. With reference to FIG. 1, (10) represents an overview of the preferred embodiment for a portable auto body estimating service cart of the present invention. It is to be noted different variations of the cart are inherent, thus the cart (10) as described in the following specification is only exemplary of one possible embodiment and therefore the invention is not to be limited thereto.

The portable auto body estimating service cart (10) of the present invention can be made from any suitable material of engineering choice, such as metal, aluminum, stainless steel, plastic, etc., or any other material which can be utilized for building a housing formed from a top panel (12), a right side panel (14), a left side panel (16), and a rear panel (18). As illustrated herein, each of the panels (12, 14, 16 & 18) are interconnected forming a frontal open compartment that is partitioned forming a top half section and a bottom half section, respectively. Top half section includes sliding support rails (20) mounted therein for supporting a drawer (22) thereon so as to allow drawer (22) to be slidably movable between an open position and a closed position. Drawer (22) further includes a handgrip (23) for easy manual manipulation between the noted positions.

Bottom half section also includes sliding support rails (24) mounted therein for supporting a tray (26) thereon so as to allow tray (26) to be slidably movable between an open position and a closed position. Further depicted in FIG. 1, bottom half section also includes a door panel (28) mounted pivotably thereon. It is to be noted door panel (28) can be mounted by any suitable fastening means of engineering choice, such as by welding, pins and brackets, etc., or such as by hinges (30) or the like. Furthermore, housing (10) is to be portable, thus rolling support means of engineering choice is to be incorporated such as either locking castors, rollers, or wheels (32), etc. The actual attachment means and construction of the sliding support rails (20 & 24) and wheels (32) is not taught herein as such knowledge is very well known within the prior art.

As further depicted in FIG. 1, housing (10) also includes an electrical connector (34) for energizing electronic equipment and the like. Again, any suitable type of electrical connector of engineering choice may be incorporated including variable voltage options such as 110 or 220, and suitable connectors and their variables are again also well taught within the prior art. Whereby, their construction and operation is not a necessity to be addressed and taught herein.

Still further, the noted electronic equipment includes numerous devices such as the following but not limited too: a battery charger for a laptop computer and/or a battery charger for a flashlight, any type of battery powered tools, digital camera with discs, a welder, etc.

As further depicted in FIG. 1, if so desired housing (10) may also include at least one locking mechanism of a suitable type according to engineering choice. For example, the locking mechanism may be of a lock and key type or of the conventional padlock (not shown) and latch (36) or the like. Also, the locking mechanism may be located at any suitable position of choice.

It can now be seen that the estimating service cart (10) of FIG. 1 is constructed in a manner so as to be user friendly for the worker and provides increased ease of use. The estimating cart is completely self-contained and provides space, compartments, and enough tools and equipment to complete a total estimate and also allows the worker to perform small temporary repairs if needed. Furthermore, the noted battery charger for the deep cell battery of the noted laptop computer allows for the computer to be functional for a prolonged period of time, such as eight hours or more.

It is to be understood, the worker can customize the components such as the tools and equipment contained within the cart to their individual liking and/or needs. This is very important so as to not only provide the worker with a feeling of security knowing that their tools and equipment are safe but also provides the worker with a feeling of confidence as they know all the tools and equipment they personally require is at hand and readily accessible all in one unit.

An example of some of the accessories, tools and equipment stored within the cart and which are typically associated with the job of estimating include but are not limited too: adhesive tape of varying colors, bailing wire, pliers, dykes, miscellaneous screwdrivers including various types thereof, a pry bar, rubbing compound, steel wool, rags, paperwork, etc. all of which can be easily stored in the cart and organized according to the liking of the worker.

It is to be noted additional options that may be easily incorporated within the cart (10) further include an upraised handgrip (38), which is most convenient as this facilitates mobility and ease of use for the worker. Yet another option may be to include a non-slip covering (40) which can be in the form of a rubberized matt, or a sprayed on coating having non-slip properties, or the like. This is most advantageous as this reduces the likelihood of objects when placed thereon from accidentally sliding and/or falling off the treated surface. This is especially helpful when a laptop computer is positioned thereon or any other highly expensive and/or sensitive equipment.

Yet another option may be to include use of color-coding. Whereby, the estimating cart may be colored blue, the teardown cart may be red, the production cart may be white, the disassembly and reassembly cart may be green, etc. Also, it may be advantageous to include color-coded keys for use with their associated color-coded cart. This would be advantageous as this allows the manager or supervisor to designate certain carts for specific jobs and/or assign certain carts to particular employees, thus they are responsible for their cart during business hours.

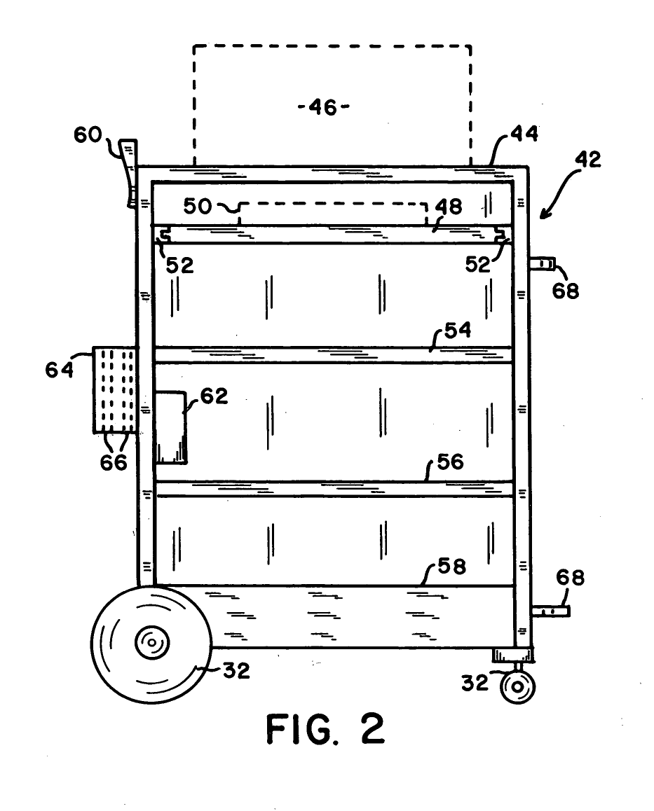

Referring now to FIGS. 2-4 wherein we depict a preferred embodiment for a different service cart, namely, a portable auto body teardown service cart (42). Wherein, the teardown cart (42) includes a housing that is formed from multiple interconnected panels which when interconnected form an enclosed cabinet, respectively. As illustrated herein the enclosed cabinet is partitioned forming multiple support shelves and each of which maybe designated for a specific purpose and/or used for storage of particular items of choice. Therefore the following is exemplary of some specified uses for the individual shelves.

Thus, the enclosed cabinet or teardown cart (42) includes a first support shelve (44) for supporting a complete toolbox (46) thereon. It is to be noted the toolbox (46) is shown in ghost lines as any typical prior art toolbox may be used and therefore the invention is not to be limited to use with any specific toolbox.

Teardown cart (42) further includes a second support shelve (48) for supporting a laptop computer (50) thereon. Again the laptop computer (50) is shown in ghost lines as any suitable type of laptop computer of choice may be used. Furthermore, second support shelve (48) is mounted on sliding rails (52) which allows second support shelve (48) to be retractable between a closed position and an open position.

Teardown cart (42) further includes a third support shelve (54) for supporting accessory components thereon. It is to be understood the noted accessory components include any articles, tools and/or equipment typically associated with the job at hand. For example, third support shelve (54) may be used for supporting a battery powered electric impact gun, a battery powered flashlight, a battery powered electric screwdriver including associated bits and/or adaptors, ZIPLOC™ bags, etc.

Teardown cart (42) further includes a fourth support shelve (56) for supporting accessory components thereon. Again, the noted accessory components include any articles, tools and/or equipment typically associated with the job at hand. For example, fourth support shelve (56) may be used for supporting electrical equipment such as a battery charger for energizing a laptop computer, a battery charger for a flashlight, a battery charger with associated jumper cables for energizing a vehicles battery, etc. It is to be understood that the noted accessory components and electronic equipment are not herein depicted as each are very well known within the prior art.

Teardown cart (42) further includes a fifth support shelve (58) for supporting at least a friction jack and/or pulling chain with an attached hook member thereon. Teardown cart (42) also includes an upraised handgrip (60) that is most convenient and functional as this facilitates mobility and ease of use for the worker. Still further, teardown cart (42) includes an electrical connector (62) such as previously described for energizing and/or charging the noted electronic equipment. Furthermore, it is to be understood the enclosed cabinet or teardown cart (42) is mounted on wheels of engineering choice, such as previously addressed.

As further depicted in FIG. 2, teardown cart (42) includes an outwardly extending receptacle (64) having apertures (66) there through for slidably receiving multiple tools therein. Again any tools of user choice may be used, such as a sledgehammer, a pry-bar, a fork, etc.

Still further teardown cart (42) includes outwardly extending support brackets (68) having apertures there through for slidably receiving and supporting elongated tools of choice, such as a pogo stick or the like.

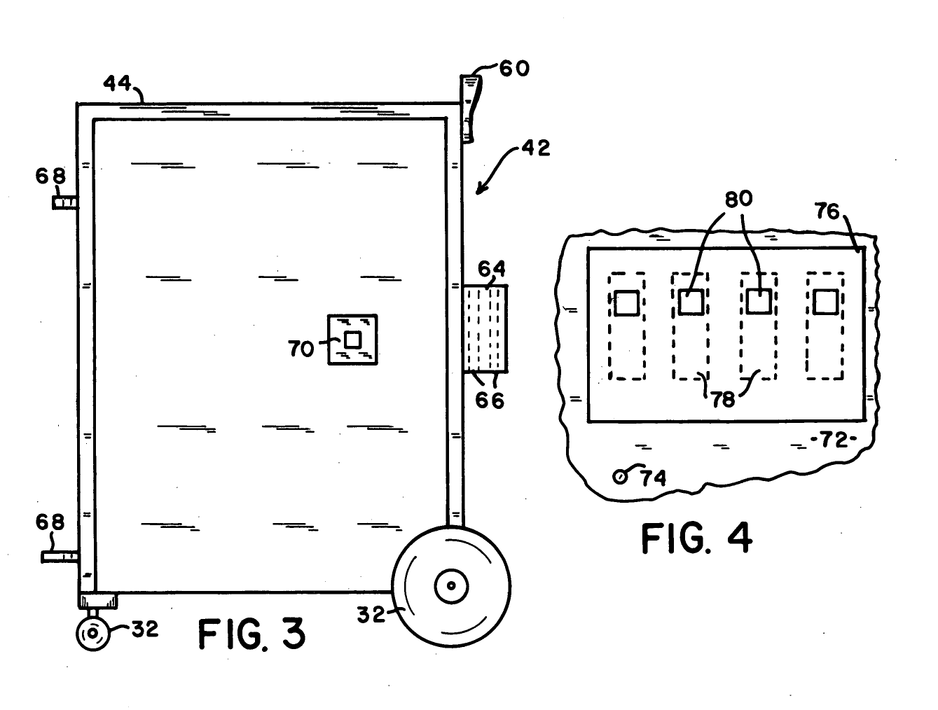

Referring now to FIG. 3 wherein we depict the backside of the portable auto body teardown service cart (42), respectively. As illustrated therein, an additional electrical connector (70) is provided, such as previously noted.

It is to be noted within FIG. 2 the teardown cart (42) is illustrated excluding an attached door panel for clarity purposes. It is to be understood that the door panel can be mounted onto teardown cart (42) by any suitable fasteners of choice. Thus the actual fasteners for mounting are not depicted herein as such suitable fasteners are very well known within the prior art.

However, it is to be understood the entire teardown cart (42) is self-contained and all of the tools and/or equipment therein/thereon can be easily locked for security purposes when not in use. Therefore, as an example within FIG. 4 we depict the door panel (72) having a locking mechanism (74) installed therein and which can be of any suitable type.

As further depicted within FIG. 4 door panel (72) of teardown service cart (42) includes a support rack (76) for supporting and slidably receiving tools of choice therein. The support rack (76) can be either of the removable type or it can be manufactured integrally within door panel (72) if preferred. Support rack (76) provides individualized compartments (78) each of which being of a shape and size to receive one of the noted tools therein. As an optional novel feature, support rack (76) may further include indicia (80) thereon pertaining to each of the various tools. For example, the noted indicia (80) may be in the form of a written description such as the word “pliers”, or indicia (80) may be in the form of a picture illustrating the actual tool itself. Whereby, a user can either read the description or they can visually determine the appropriate tool and its corresponding compartment. This is not only convenient as the tools are always in their proper compartment even when used by different workers and this further serves to encourage the workers to be organized and also reduces the occurrence of accidental loss.

It will now be seen we have herein provided a portable auto body teardown service cart which is completely self-contained, includes secure locking means for locking the cart with all of the tools and components, and can be used for a complete teardown procedure. Also, and most important the teardown cart (42) is of a size and shape to easily fit in between vehicles when parked in a side-by-side relationship. This is very advantageous as this allows the worker to perform the task without the need to move the vehicle to the workstation rather the workstation is brought to the vehicle.

As previously addressed, the invention is only exemplary of some types of service carts, namely we herein provide an estimating cart and a teardown cart. However, other embodiments maybe included, such as a production cart, a disassembly/reassembly cart, bodywork cart, replace welded parts cart, mechanical cart, frame cart, etc. Each of which are substantially similar, respectively, but include different components and/or tools or they may include additional compartments or the like depending on the job to do. As previously noted the present service cart may be used within different types of businesses and/or by workman to perform substantially any job at hand of user choice.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described our invention, what we claim as new and desire to secure by Letters Patent is:

1. A portable auto body estimating service cart comprising: a housing formed from a top panel; a bottom panel; a right side panel; a left side panel; and a rear panel; each said panel being interconnected forming a frontal open compartment, said frontal open compartment being partitioned forming a top half section and a bottom half section, said top half section having sliding support rails mounted therein for supporting a drawer thereon, said drawer being slidably movable between an open position and a closed position, said bottom half section having sliding support rails mounted therein for supporting a tray thereon, said tray being slidably movable between an open position and a closed position, said bottom half section having a door panel pivotably mounted thereon, said housing being mounted on at least four wheels and said top panel having a non-slip material thereon.

2. The portable auto body estimating service cart of claim 1 wherein said housing further includes an electrical connector for energizing electronic equipment.

3. The portable auto body estimating service cart of claim 2 wherein said electronic equipment includes at least a battery charger for energizing a laptop computer.

4. The portable auto body estimating service cart of claim 2 wherein said electronic equipment includes at least a battery charger for energizing a flashlight.

5. The portable self-contained service cart of claim 1 is an auto body estimating service cart.

6. A portable self-contained service cart comprising:
a housing formed from multiple interconnected panels which when interconnected form an enclosed cabinet, said enclosed cabinet having a locking mechanism, said enclosed cabinet is of a shape and size to fit in between vehicles when said vehicles are parked side-by-side, said enclosed cabinet being partitioned forming multiple support shelf's, said multiple support shelf's having a non-slip material thereon, said multiple support shelf's including a first support shelf for supporting a complete toolbox thereon, a second support shelf for supporting a laptop computer thereon, said second support shelf being mounted on sliding rails, said sliding rails allowing said second support shelf to be retractable between a closed position and an open position, a support rack for supporting tools therein, and said enclosed cabinet being mounted on at least four wheels.

7. The portable self-contained service cart of claim 6 further includes a third support shelf for supporting accessory components thereon.

8. The portable self-contained service cart of claim 6 further includes a fourth support shelf for supporting accessory components thereon.

9. The portable self-contained service cart of claim 6 further includes a fifth support shelf for supporting thereon at least a pulling chain with an attached hook.

10. The portable self-contained service cart of claim 6 wherein said enclosed cabinet further includes an electrical connector for energizing electronic equipment and/or any battery powered tools.

11. The portable self-contained service cart of claim 10 wherein said electronic equipment includes at least a battery charger for energizing a laptop computer.

12. The portable self-contained service cart of claim 10 wherein said electronic equipment includes at least a battery charger for energizing a flashlight.

13. The portable self-contained service cart of claim 10 wherein said electronic equipment includes at least a battery charger with jumper cables.

14. (canceled)

15. (canceled)

16. The portable self-contained service cart of claim 6 is an auto body teardown service cart.

17. The portable self-contained service cart of claim 6 wherein said locking mechanism is actuated with a key and said key and said enclosed cabinet being color coded to match.

18. The portable self-contained service cart of claim 17 wherein said key and said enclosed cabinet are color coded blue, and said enclosed cabinet is used as an estimating cart.

19. The portable self-contained service cart of claim 17 wherein said key and said enclosed cabinet are color coded red, and said enclosed cabinet is used as a teardown cart.

20. The portable self-contained service cart of claim 17 wherein said key and said enclosed cabinet are color coded white, and said enclosed cabinet is used as a production cart.

21. The portable self-contained service cart of claim 17 wherein said key and said enclosed cabinet are color coded green, and said enclosed cabinet is used as a disassembly and reassembly cart.

22. The portable self-contained service cart of claim 6 further includes an outwardly extending receptacle having apertures there through for slidably receiving multiple tools therein.

23. The portable self-contained service cart of claim 6 further includes an outwardly extending support brackets having apertures there through for slidably receiving and supporting elongated tools therein.

24. The portable self-contained service cart of claim 6 wherein said support rack for supporting tools therein further includes indicia thereon pertaining to each said tools.

25. The portable self-contained service cart of claim 24 wherein said indicia is in the form of a written description.

26. The portable self-contained service cart of claim 24 wherein said indicia is in the form of a picture illustrating an actual tool itself.
